(19) United States
(12) Patent Application Publication
(10) Pub. No.: US 2009/0240608 A1
(43) Pub. Date: Sep. 24, 2009

(54) Methods of an auditor querying an audit log for a database which contains records of image-based check deposit transactions

(75) Inventor: Timothy J. Mashinter, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/077,797

(22) Filed: Mar. 21, 2008

(51) Int. Cl. G06Q 40/00

(52) U.S. Cl. 705/30

(57) ABSTRACT

A method is provided of an auditor operating an auditor terminal to query an audit log for a database which contains records of check deposit transactions. The method comprises on a first display screen, entering in a customer name, on a second display screen, selecting a link which corresponds with a particular check deposit transaction associated with the customer name, and on a third display screen, receiving audit details associated with the particular check deposit transaction.

### BACKGROUND

The present invention relates to audit logs for a database which contains records of image-based check deposit transactions, and is particularly directed to methods of an auditor querying an audit log for a database which contains records of image-based check deposit transactions.

In a typical image-based check deposit transaction, check image data is lifted from a check being deposited. Also, check deposit transaction data is generated. The captured check image data and the associated check deposit transaction data are transmitted to and stored in a database server at a data center. A unique identification (ID) number is associated with each record stored in the database server at the data center. When the check image data and the check transaction data are initially stored in the database server at the data center, this event is recorded in an audit log.

At a later time, certain bank personnel may need to access the check image data and the associated check transaction data stored in memory at the data site. For example, an operator working at a terminal of a keying and balancing workstation may need to access the check image data and check deposit transaction data of particular check items to perform known functions such as amount keying, codeline completion, or balancing. The keying and balancing workstation is typically located at a back office facility of a financial institution such as a bank. When check image data and check deposit transaction data for a check item has been retrieved, this event is also recorded in the audit log.

From time to time, an auditor needs to query the audit log. The auditor may be an employee of the bank or may be an outside third party. The audit log contains many event recordings and is usually quite large. The auditor would ideally like to have the unique ID number associated with each record contained in the audit log when a query is made to the audit log. However, the auditor usually does not know the unique ID number associated with each record contained in the audit log.

Since the audit log is usually quite large and the auditor usually does not know the unique ID number associated with each record, it is often quite cumbersome and inefficient for the auditor to even query the audit log, let alone analyze results found from queries. It would be desirable to provide an improved method for an auditor to query the audit log and conduct a search on records contained in the audit log.

### SUMMARY

In accordance with an embodiment of the present invention, a method is provided of an auditor operating an auditor terminal to query an audit log for a database which contains records of check deposit transactions. The method comprises on a first display screen, entering in a customer name, on a second display screen, selecting a link which corresponds with a particular check deposit transaction associated with the customer name, and on a third display screen, receiving audit details associated with the particular check deposit transaction.

### BRIEF DESCRIPTION OF THE DRAWINGS

In the accompanying drawings:

FIG. 1 is a block diagram of an auditor terminal which communicates with a data center which communicates with a remote check image capture device;

FIG. 2 is a schematic block diagram showing one form (a table-top check processing terminal) of the remote check image capture device of FIG. 1;

FIG. 3 is a schematic block diagram showing another form (an image-based check processing system) of the remote check image capture device of FIG. 1;

FIG. 4 is a flowchart depicting steps taken by an auditor at the auditor terminal of FIG. 1 performing an audit in accordance with an embodiment of the present invention;

FIGS. 5 and 6 are display screens provided in accordance with certain steps shown in the flowchart of FIG. 4.

### DETAILED DESCRIPTION

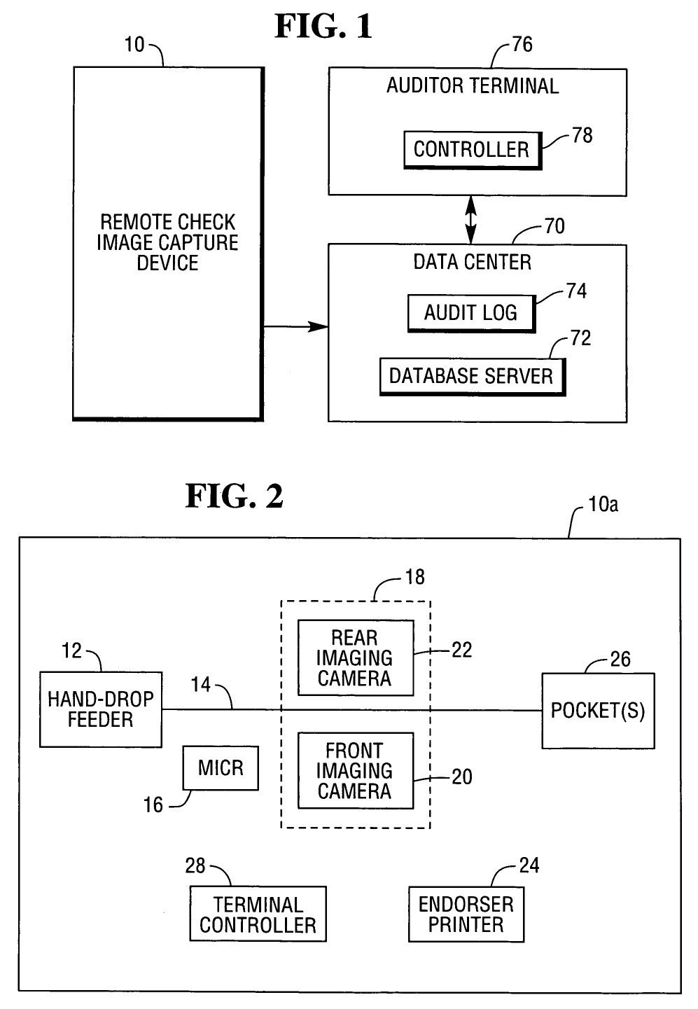

The present invention is directed to methods of an auditor querying an audit log for a database which contains records of image-based check deposit transactions. Referring to FIG. 1, a remote check image capture device 10 is illustrated. The remote check image capture device 10 captures data from a physical check which has been deposited and being processed. The captured image data is representative of an image of the check.

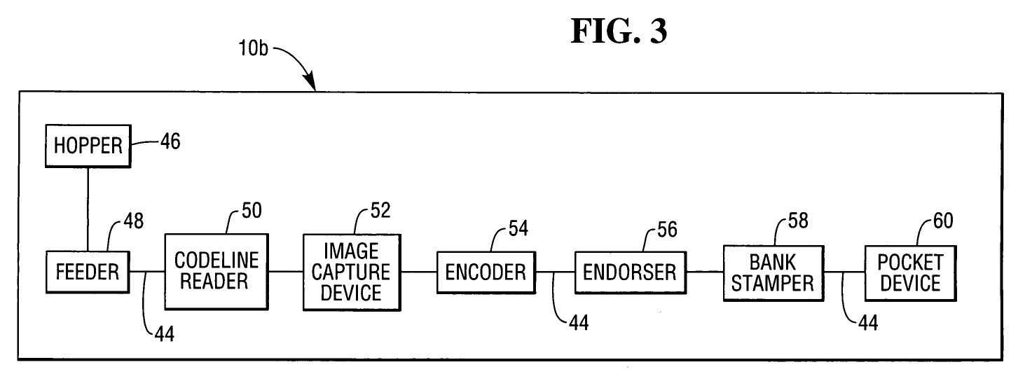

There are many forms that the remote check image capture device 10 may take. One example of the remote check image capture device 10 is in the form of a table-top check processing terminal 10a as shown in FIG. 2. The terminal 10a may be located at a bank branch, for example, where bank personnel use the terminal to perform check processing functions. As another example, the terminal 10a may be located at a commercial client's facility where check image capture processing is performed.

The table-top terminal 10a comprises the following elements: a hand-drop check feeder 12, a check transport mechanism 14 including an alignment mechanism for aligning a check; a magnetic ink recognition character (MICR) head 16 for reading magnetic details on a code line of a check; an imager 18 including a front imaging camera 20 and a rear imaging camera 22 for capturing a grayscale image of each side of a check (front and rear); a printer 24 for endorsing a check; and a number of check storage bins 26 in the form of pockets for storing processed checks. An automated check feeder may be used instead of the hand-drop check feeder 12. Also, the use of the MICR head 16 in some applications may be optional. The elements are conventional and will not be described in detail herein. The terminal 10a also includes a controller 28 for controlling the operation of the elements within the terminal.

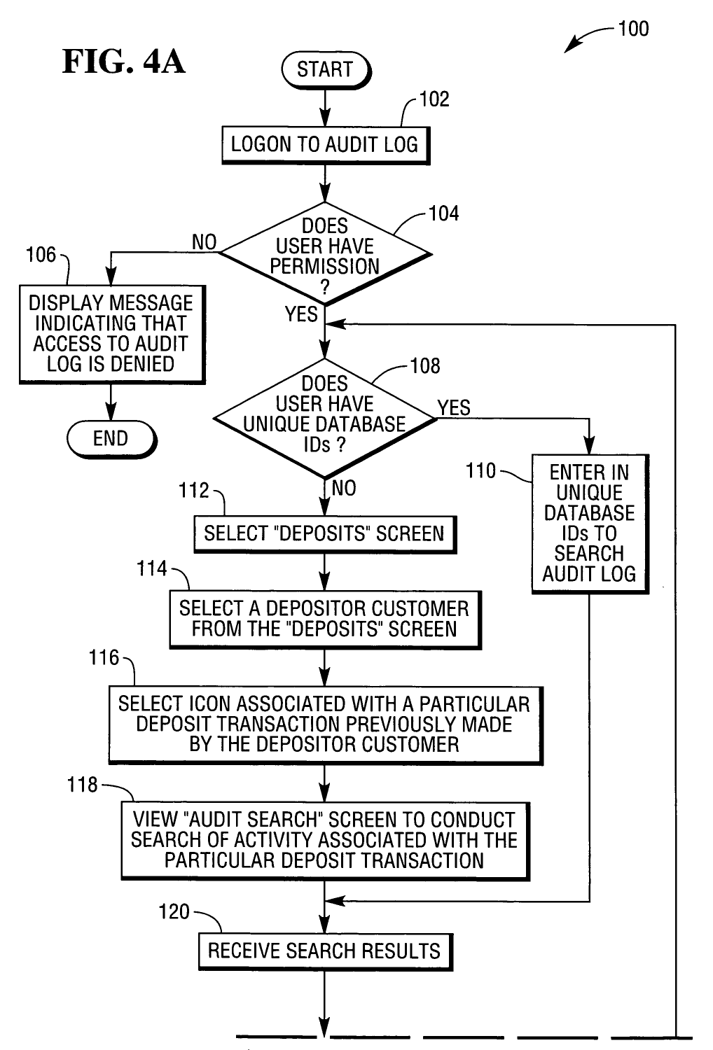

Another example of the remote check image capture device 10 of FIG. 1 is in the form of an image-based check processing transport 10b as shown in FIG. 3. The specific construction and use of the image-based check processing system 10b may vary. The check processing system 10b may be, for example, a sorting machine or a proof machine wherein financial document items are processed in a bank. The financial document items may be in any number of forms. For examples, a financial document item may be in the form of a check, a deposit slip, a cash-in slip, or a cash-out slip.

The check processing transport 10b has a document track 44 along which financial document items, such as checks, can be transported from an upstream end to a downstream end. The transport 10b includes a number of different check processing modules positioned along the document track 44. Each check processing module includes a number of devices associated with the particular check processing module for performing specific document processing operations on document items moving along the document track. The transport 10b includes a hopper 46 into which a stack of financial document items including checks are placed. A document feeder 48 adjacent the hopper 46 selectively feeds or drives each document item from the stack of document items in the hopper to transport the document item from the upstream end to the downstream end along the document track 44.

The check processing transport 10b also includes a codeline reader 50 such as a magnetic ink character recognition (MICR) reader located along the document track 44. The MICR reader 50 reads a MICR codeline from each check being processed in a known manner. The check processing system 10b further includes an image capture device 52 located along the document track 44. The image capture device 52 captures images of the front and rear of each document item for a number of different purposes well known in the financial industry. More specifically, the image capture device 52 includes a front imaging camera and a rear imaging camera (both not shown) which are controlled to capture images of document items moving along the document track 44. The structure and operation of MICR readers, OCR readers, and imaging cameras are well known and, therefore, will not be described.

The check processing transport 10b may optionally include an encoder 54, an endorser 56, or a bank stamper 58, as shown in FIG. 3. The encoder 54 encodes missing fields on each check. The endorser 56 applies an endorsement in a known manner to each check. The bank stamper 58 stamps each check to identify the bank institution processing the check. The structure and operation of encoders, endorsers, and bank stampers are well known and, therefore, will not be described. Processed checks are directed and sorted into pockets of a pocket device 60.

Referring again to FIG. 1, captured check images and associated check deposit transaction data are transmitted from the remote check image capture device 10 to a data center 70. Check images and associated check deposit transaction data are stored in a database server 72 at the data center 70. The event of the check images and associated check deposit transaction data being stored in the database server 72 is recorded in an audit log 74 located at the data center 70.

The audit log 74 is for the database server 72 which contains records of check deposit transactions which have been previously remotely captured such as at the remote image capture device 10. More specifically, the audit log 74 stores events which have occurred for each record contained in the database server 72. As an example, an event of a particular record being retrieved, changed, and then stored again is recorded in the audit log 74. As another example, an event of a particular record being deleted is recorded. Still as another example, an event of a particular record being accessed for read-only is recorded. These events are examples only, and other events are possible.

As shown in FIG. 1, an auditor terminal 76 is located remote from the data center 70. The auditor terminal 76 includes a controller 78 which communicates with the audit log 74 at the data center 70. A human operator at the auditor terminal 70 interacts with the controller 78 to query the audit log 74. The audit log 74 may be queried for any number of reasons. As an example, the audit log 74 may be queried to show all transactions conducted by a particular customer. As another example, the audit log 74 may be queried to show activity details of transactions conducted by a particular customer. Still as another example, the audit log 74 may be queried to all details of a particular transaction conducted by a particular customer. These queries of the audit log 74 are examples only, and other queries are possible.

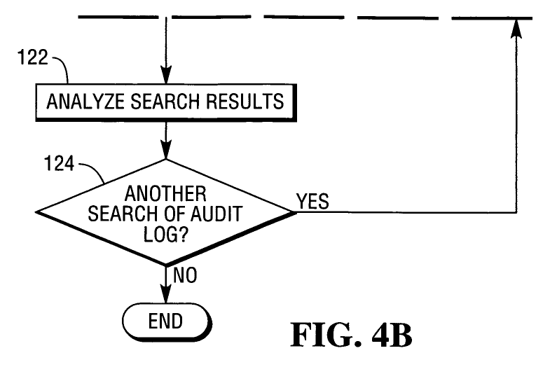

Referring to FIG. 4, a flowchart 100 depicts steps performed by an auditor located at the auditor terminal 76 and performing an audit of the audit log 74 in accordance with one embodiment of the present invention. The auditor interacts with the controller 78 to log onto the auditor terminal 76 (step 102). After the auditor logs on, a determination is made as to whether the auditor has permission to access the audit log 74 (step 104). Methods of granting permission to a user are conventional and well known and, therefore, will not be described. If the determination in step 104 is negative (i.e., the auditor has no permission to access the audit log 74), then a message will be displayed on a display screen of the auditor terminal 80 to inform the auditor that access to the audit log 74 has been denied (step 106). However, if the determination in step 104 is affirmative (i.e., the auditor has permission to access the audit log 74), then a determination is made as to whether the auditor has unique database identification codes (IDs) to query the audit log 74 (step 108).

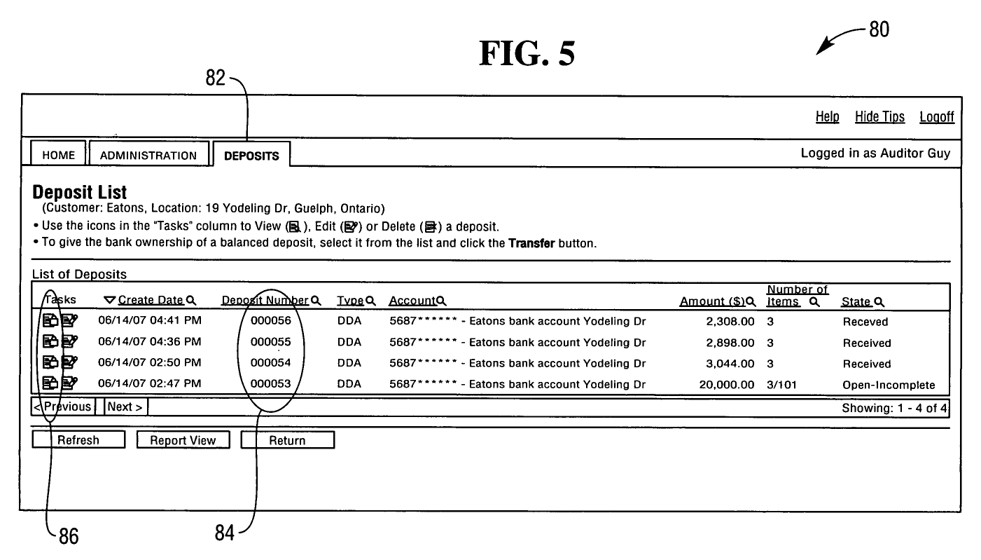

If the determination in step 108 is affirmative (i.e., the auditor has unique database IDs for querying the audit log 74, the auditor proceeds to make queries to the audit log 74 by entering unique database IDs (step 110). The process then proceeds from step 110 to step 120. However, if the determination in step 108 is negative (i.e., the auditor does not know or have unique database IDs for querying the audit log 74), the auditor proceeds to enter a customer name (“Eaton” in this example) and selects from a display screen 80 (such as shown in FIG. 5) a tab 82 labelled “DEPOSITS” (steps 112 and 114). As shown in FIG. 5, the DEPOSITS display screen 80 includes a number of deposit transactions which have been conducted by customer Eaton. Four deposit transactions 84 (i.e., 000053, 000054, 000055 and 000056) are shown in FIG. 5.

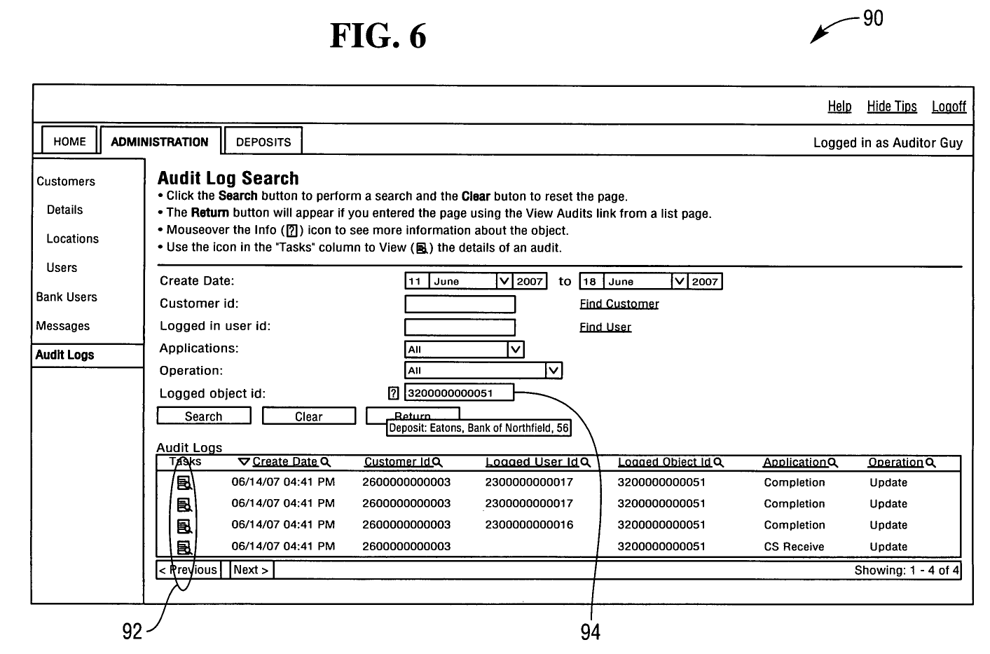

In accordance with this embodiment of the present invention, four task icons 86 are associated with the four deposit transactions 84. More specifically, each one of the icons 86 is associated with a corresponding one of the four deposit transactions 84. When the auditor selects one of the icons 86 (step 116 in FIG. 4), a display screen 90 (such as shown in FIG. 6) is presented on the display of the auditor terminal 80 for the auditor to view. In this particular example, the auditor selected from the display screen of FIG. 5 the icon which is associated with “Deposit Number 000056” to provide the display screen 90 of FIG. 6.

As shown in the display screen 90 of FIG. 6, details associated with Deposit Number 000056 are either displayed or can be obtained by selecting one of a number of icons 92. When the auditor selects one of the icons 92 from the display screen 90 of FIG. 6, another display screen (not shown) showing particular transaction details associated with Deposit Number 000056 will be displayed on the display of the auditor terminal 80. Also, as shown in the display screen 90 of FIG. 6, the unique database ID (i.e., “3200000000051” in this particular example) is shown in box 94.

It should be apparent that the unique database ID shown in box 94 in the display screen 90 of FIG. 6 was previously unknown to the auditor until the auditor selected the corresponding one of the icons 86 shown in the display screen 80 of FIG. 5. When the auditor selected the one of the icons 86 shown in the display screen 80 of FIG. 5, this selection linked the auditor to the display screen 90 of FIG. 6 which contains all of the search criteria pre-filled so that the auditor can easily find the audits for the particular deposit transaction (i.e., Deposit Number 000056 in this example). If the auditor had gone directly to the display screen 90 shown in FIG. 6 without having to first go through the one of the icon links 86 shown in the display screen 80 of FIG. 5, then the auditor would have needed to provide the unique database ID (i.e., “3200000000051”) before the auditor could have continued the search from the display screen 90 shown in FIG. 6. Thus, by providing the auditor with the icon links 86 shown in the display screen 80 of FIG. 5, the auditor was able obtain transaction details associated with a particular deposit transaction without having to provide the unique database ID associated with the particular deposit transaction. This is advantageous as the auditor will usually not know the unique database ID associated with a particular transaction when the auditor is logged onto the auditor terminal 76 and querying the audit log 74.

After the auditor is presented with the display screen 90 shown in FIG. 6, the auditor obtains search results from this display screen (step 120 in FIG. 4), and analyzes search results (step 122) as needed. A determination is then made as to whether there is another search of the audit log 74 which needs to be conducted (step 124). If the determination in step 124 is negative (i.e., there is no other search of the audit log 74 needed), the process terminates. However, if the determination in step 124 is affirmative (i.e., there is another search of the audit log 74 needed), the process proceeds back to step 108 to allow the auditor to conduct the next query of the audit log 74.

Although the above description describes four deposit transactions in the display screen 80 shown in FIG. 5, it is conceivable that there could be any number of deposit transactions in the display screen.

Also, although the above description describes the audit log 74 as being located at the data center 70, it is conceivable that the audit log may be located remote and away from the data center. Also, although the above description describes the auditor terminal 70 as being located remote from the data center 70, it is conceivable that the auditor terminal may be located in the data center.

Further, although the above description describes the remote check image capture device 10 (FIG. 1) as being in the form of the image-based check processing system (FIG. 3), the remote check image capture device may be in other forms. As previously mentioned with reference to FIG. 2, the remote check image capture device 10 may comprise a table-top check processing terminal 10a which is located at a bank branch or at a commercial client's facility at which check image capture processing is performed. These locations are only examples of where the table-top check processing terminal 10a can be used. The table-top check processing terminal 10a may be used in other locations at which grayscale images of original physical checks are captured.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A method of an auditor operating an auditor terminal to query an audit log for a database which contains records of check deposit transactions to obtain audit details associated with a particular check deposit transaction of a particular depositor customer, the method comprising:
on a first display screen, entering in name of the particular depositor customer;
on a second display screen, selecting an iconic hyperlink which corresponds with the particular check deposit transaction associated with the name of the particular depositor customer; and
on a third display screen, receiving audit details associated with the particular check deposit transaction without having to provide any unique identification code associated with the particular check deposit transaction of the particular depositor customer.

2-5. (canceled)

6. A program storage medium readable by a computer having a memory, the medium tangibly embodying one or more programs of instructions executable by the computer to perform method steps for enabling an auditor to audit an audit log for a database which contains records of check deposit transactions, the method comprising the steps of:
presenting a first display screen for allowing the auditor to provide a name of a particular depositor customer; and
presenting a second display screen for allowing the auditor to select an iconic hyperlink associated with a particular check deposit transaction of the particular depositor customer and thereby to open up and present a third display screen which contains audit details associated with the particular check deposit transaction without having the auditor provide any unique identification code associated with the particular check deposit transaction.
